(19) United States
(12) Patent Application Publication
(10) Pub. No.: US 2002/0109633 A1
(43) Pub. Date: Aug. 15, 2002

(54) Low cost microstrip antenna

(76) Inventors: Steven Ow, Thousand oaks, CA (US); Peter Connolly, Camarillo, CA (US); Robert McCarthy, Newbury Park, CA (US)

Correspondence Address: William J. Benman, Suite 2740, 2049 Century Park East, Los Angeles, CA, 90067, US

(21) Appl. No.: 09/783,050

(22) Filed: Feb. 14, 2001

(51) Int. Cl. H01Q 1/38

(52) U.S. Cl. 343/700 MS

(57) ABSTRACT

An low cost stacked microstrip antenna and low cost method of making the same are disclosed. By using specially designed bandwidth and directivity parameters in conjunction with lower cost dielectric, materials economies of production are realized. In particular, dielectric support layers made from fine cell foam sheet material that is mass produced for primary purposes other than electrical insulation materials, are used to reduce cost. A stackable design used in conjunction with a capacitively coupled feedline connector reduce assembly costs as well.

### BACKGROUND OF THE INVENTION

1. Field of the Invention

The present invention relates to antennas. More specifically, the present invention relates to low cost microstrip antennas designed and manufactured using a stack of components.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

2. Description of the Related Art

Microstrip antennas are well known in the art. Microstrip antennas generally operate in VHF, UHF, and higher frequency ranges where the electromagnetic wavelengths are short enough to allow relatively compact resonant structures to act as transmitting and receiving antennas. Such antennas comprise a stack of elements including a conductive ground plane shield, dielectric support layer, and microstrip antenna layer. There are sometimes a greater number of stacked elements which may include an additional dielectric support layer and an electromagnetically coupled patch radiator element layer. The antenna and patch radiator element layers are generally a printed circuit created from a copper clad dielectric board that is photo chemically etched to form an array a patch radiator elements which may be coupled with microstrip transmission lines.

Because there is a need to carefully control resonant frequency, impedance, antenna gain, and directivity, stacked microstrip antennas are built from components with highly predicable parameters. Important parameters include dimensional predictability and stability, predictable dielectric and conductance characteristics, and impedance generally. Since antennas operate in harsh environments, the foregoing parameters must also withstand broad fluctuations in temperature and humidity.

Historically, high frequency radio equipment was first utilized in military, government, and sophisticated commercial applications. In such applications, the cost of the antennas structures is a relatively small portion of system cost, so that designers were free to utilize the best available materials in antenna construction. The best available materials are naturally the most expensive materials.

With the broad application of radio technology into mass consumer markets, the utilization of VHF, UHF, and higher frequency radio equipment has become commonplace. Wireless technology products like cellular telephone, personal communications services, and wireless local loop telephony are examples of such broad commercial applications. The economies of scale have greatly reduced the cost the radio components such as oscillators, mixers, PLL's, combiners, power amplifiers and so forth that operate at higher radio frequencies. Much of this radio equipment operates in mobile environments and therefore utilize omni-directional antennas. Naturally then, the mass production of omni-directional antennas has driven the cost of these down as well.

The fixed radio environment also enjoys the low cost of radio components made available through the mass consumer markets. However, fixed radio systems can take advantage of antennas structures with higher gain and directivity to improve system performance, so the low cost omni-directional antennas are not suitable. The mass produced markets have not forced down the cost of components for higher gain antennas, such as stacked microstrip array antennas operable at UHF and higher frequencies, in proportion with the cost of other system components. Therefore, the cost of such antennas is too high, and out of proportion with the system cost generally.

Thus there is a need in the art for a device and method to provide low cost directional antennas that operation in the VHF, UHF, and higher frequency range, such as stacked microstrip antennas, at a cost that is reduced in reasonable proportion to the otherwise reduced components cost of mass produced radio systems.

### SUMMARY OF THE INVENTION

The need in the art is addressed by the apparatus and methods of the present invention. The inventive apparatus is a low cost microstrip antenna with a shield that has a first planar, conductive, surface with a hole in it, and a microstrip antenna board that has a microstrip feedline coupled to a radiating element on a first surface. The low cost microstrip antennas further has a feed support, fabricated from a fine cell irradiation cross linked polyolefin foam sheet material, that has substantially the same planar dimensions as the microstrip antenna board, and a feedline connector with a coupling connector located in the hole in the shield so that the coupling connector is exposed at the first surface of the shield. Also, a feedline insulator covering covers the coupling connector of the feedline connector. The arrangement of these components is such that the feed support is placed adjacent to the first surface of the shield thereby insulating it from the microstrip antenna board, which is placed adjacent to the feed support with the first surface of the microstrip antenna board oriented to face the shield, and, the microstrip antenna board oriented so that the microstrip feedline is oriented adjacent to the coupling connector of the feedline connector and insulated from it by the feedline insulator, thereby forming a capacitive coupling between the two.

In a more complex antennas design, the antenna further has a patch radiator board with one or more patch radiator elements on a first surface and a patch support, fabricated from a twinwall corrugated polyolefin resin sheet material, and having substantially the same planar dimensions as the patch radiator board. The arrangement of these additional components is such that the patch support is located adjacent to a second surface of the microstrip antenna board, and the first surface of the patch radiator board is located adjacent to the patch support and positioned so that the patch radiating element is electromagnetically coupled to the radiating element of the microstrip antenna board.

### BRIEF DESCRIPTION OF THE DRAWINGS

FIG. 1 is an isometric view of the preferred embodiment.

FIG. 2 is an expanded isometric view of the preferred embodiment.

FIG. 3A is a bottom view and FIG. 3B is a cross section of the preferred embodiment.

FIG. 4 is a section detail of the antenna feed connection in an illustrative embodiment.

### DESCRIPTION OF THE INVENTION

Illustrative embodiments and exemplary applications will now be described with reference to the accompanying drawings to disclose the advantageous teachings of the present invention.

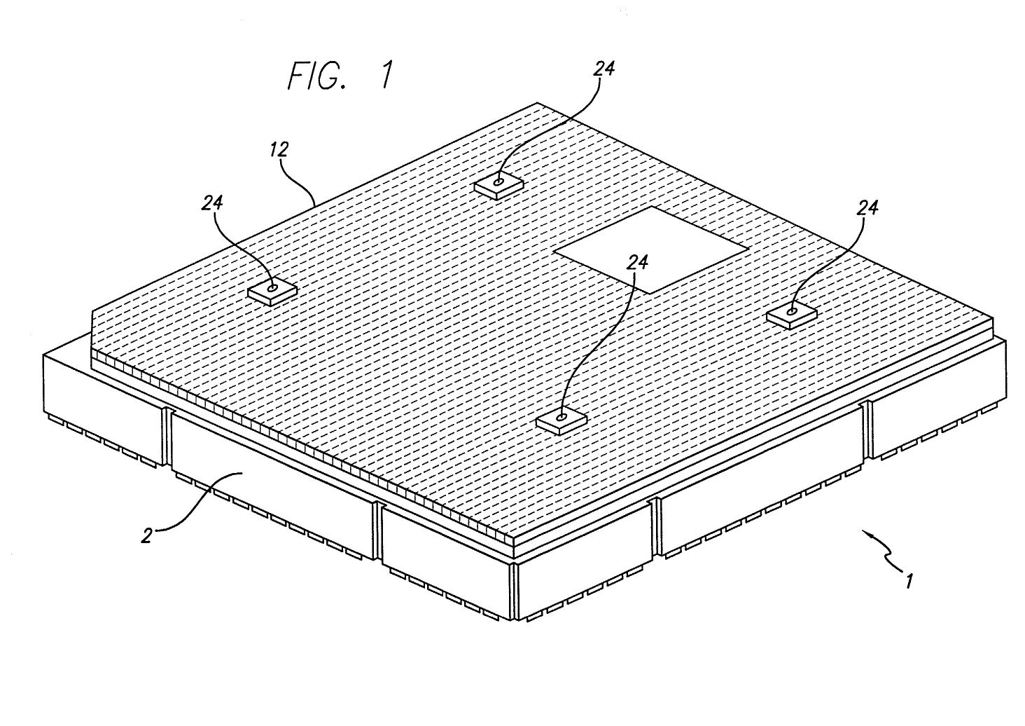

Reference is directed to FIG. 1 which is an isometric view of the assembled microstrip antenna 1 in the preferred embodiment. The antenna shield 2 forms the foundation of the antenna and is fabricated from metal or metalized plastic so as to form a conductive, planar, surface onto which the other antenna elements are assembled by stacking. The stack of antenna elements (not clearly shown in this view) is covered and protected by a rigid plastic cover support 12 which is held in place by plastic fasteners 24.

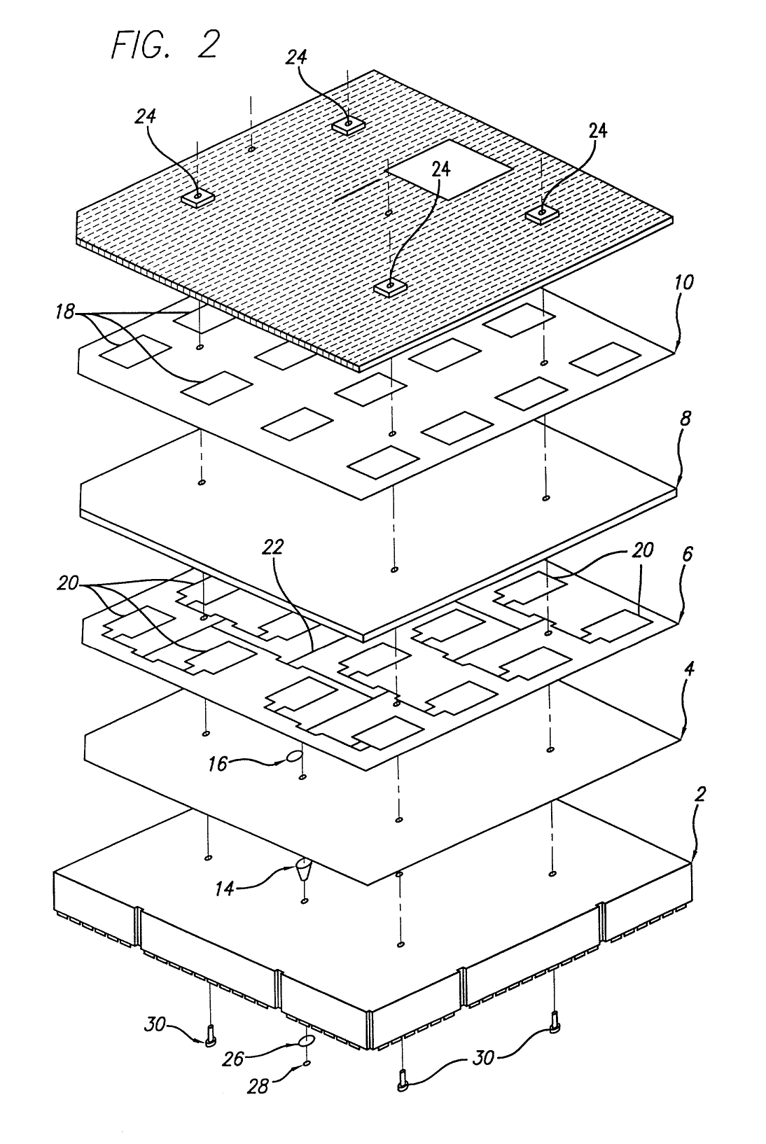

FIG. 2 illustrates an exploded isometric view of the microstrip antenna 1 in the preferred embodiment. The antenna shield 2 has a rigid metal or metalized planar surface on its top which forms the platform onto which the other antenna elements are stacked. To facilitate coupling of radio frequency signals to and from the antenna, a feedline connector 14 is inserted into a hole formed in the surface of antenna shield 2. The feedline connector is held captive by a washer 26 and nut 28 which are tightened against the bottom surface of antenna shield 2. In the preferred embodiment, the feedline connector is a modified type ‘MCX’ connector, which is more fully detailed in FIG. 4.

Microstrip antennas are well known in the art and typically comprise one or more copper clad printed circuit board which have been photo etched to form one or more radiating patches which are coupled by microstrip feedlines. The thickness and dielectric constant of the printed circuit board substrate as well as the width of the microstrip feed lines determine the impedance of the feedlines. Since microstrip antennas are typically designed to be resonant structures, the size of the radiating patches determine the resonant frequency of operation of the antenna. A plurality of radiating patches may be used to form and array of antenna elements which are sized and spaced to control gain, directivity and polarization of the antenna. In more sophisticated designs, there may be a second printed circuit board located adjacent to the first printed circuit board which has an array of electromagnetically coupled patch radiating (ECPR) elements. These elements correspond to the aforementioned array of feedline driven elements, and are usually located directly opposite one another. These two printed circuit boards are separated by a dielectric spacer.

Returning to FIG. 2, a feed support 4 is stacked on top of antenna shield 2. The feed support 4 serves to form a dielectric layer between the conductive upper surface of antenna shield 2 and the microstrip array antenna elements (discussed below) that are placed on top of feed support 4. As was discussed, the characteristics of the feed support material control the impedance, gain, bandwidth, and other operating parameters of the finished antenna. In the prior art, microwave grade materials, such as Duroid class materials, are employed. These materials are expensive. In the present invention, commercial grade packing materials are used. These materials are closed cell plastic foam, such as Volara brand foam manufactured by Voltek. Volara brand foam is a fine celled irradiation crosslinked polyolefin foam. Volara brand material was chosen because of its desirable dielectric characteristics and it is available in thickness' ranging from 30 to 125 thousandths of an inch. The use of this material represents a cost savings of approximately 20 to 1 over the microwave class materials. While the commercial packing foam materials are not as uniform in dimension and characteristics as the microwave class materials, in the present invention, the bandwidth characteristics of the antenna are broadened to a sufficient degree to encompass the variations in the foam packing material such that the finished antenna will operate within the desired parameters. Those skilled in the art will understand the techniques employed to control the bandwidth of a stacked microstrip array antenna.

A microstrip antenna board 6 is placed on top of the feed support 4 with the copper clad feedlines 22 and radiating patches 20 facing downward. With this arrangement, the spacing between the copper cladding and the upper surface of antenna shield 2 is entirely controlled by feed support 4. The position of the microstrip feedlines 22 on microstrip antenna board 6 are such that the feedline aligns directly over feedline connector 14 located in antenna shield 2. This arrangement creates a capacitive coupling of radio frequency signals between feedline connector 14 and microstrip 22. To prevent direct conductive coupling, a feedline insulating covering 16 is placed on top of feedline connector 14 during the assembly of the antenna. In the preferred embodiment, mylar or Kapton tape is used.

A patch support 8 is placed on top of microstrip antenna board 6 to form a second dielectric layer. Like the feed support layer 4, the patch support 8 is fabricated, not from microwave class dielectric materials, but from commercial grade foam packing materials. In the preferred embodiment, the material for the patch support 8 is Coroplast brand packaging sheet material. Coroplast is a twinwall corrugated plastic sheet material, much like corrugated cardboard, which is made from polyolefin resin. This foam was chosen because of its desirable dielectric characteristics and it is available in thickness' ranging from 60 to 250 thousandths on an inch. The Coroplast and foam may be antistatic treated for static sensitive applications. The choice of this material represents a cost savings factor of approximately 20 to 1 over microwave class materials.

A patch radiator board 10 is stacked on top of patch support 8. The patch radiator board 10 is a copper clad printed circuit board which has been etched to for an array of ECPR elements 18 that correspond to the patch elements 20 on microstrip antenna board 6. The ECPR elements 18 are driven by electromagnetic coupling, and the degree of this coupling is controlled by the thickness and dielectric constant of patch support 8.

To complete the assembly of the microstrip antenna in the preferred embodiment, a rigid plastic cover support 12 is placed on top of patch radiator board 10. In the preferred embodiment, all of the antenna shield 2, feed support 4, microstrip antenna board 6, patch support 8, patch radiator board 10, and support 12 are formed from planar materials to approximately the same dimensions. Each also has a plurality of holes formed in them and aligned so that screw fasteners 30 pass through all layers and fasten to plastic nut fasteners 24. These fasteners serve to clamp the layers together and align them.

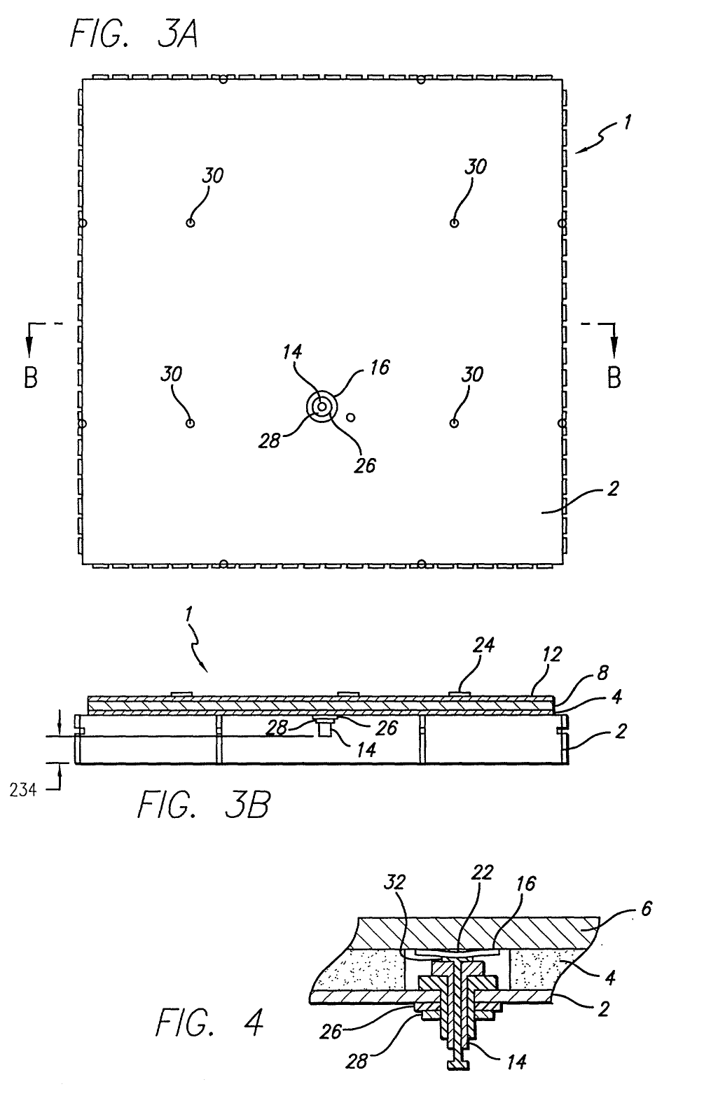

Reference is now directed to FIG. 3A which is a bottom view of the microstrip antenna 1 in the preferred embodiment. Antenna shield 2 is visible with feedline connector 14 located in a hole in antenna shield 2. The feedline connector 14 is retained in place by washer 26 and nut 28. Also shown, in phantom, is feedline insulating covering 16. Screw fasteners 30 are located about the surface, to adequately retain and align the layers.

Reference is now directed to FIG. 3B which is a cross section of the microwave antenna 1 in the preferred embodiment. Antenna shield 2 forms the base structure onto which the layers are stacked. In this view, feed support 4, patch support 8, and rigid plastic cover support 12 are visible. Plastic nut fasteners 24 are visible. Feedline connector 14 is located in the hole in antenna shield 2, and is retained by washer 26 and nut 28.

Reference is directed to FIG. 4 which is a section detail of the antenna feed connector. Antenna shield 2, with a holed formed therein forms the base. Feed support 4 also has a holed formed therein which is aligned with the hole in antenna shield.2. The feedline connector 14 is inserted into the hole from the top and is retained by washer 26 and nut 28. A standard type ‘MCX’ male or other coaxial connector is used as the feedline connector 14, but is modified with a flat disc end 32 that is used to form a tuned capacitive junction with the microstrip feedline 22 located on the bottom of microstrip antenna board 6. The junction between disc 32 and microstrip feedline 22 is maintained as a capacitive junction by inserting feedline connector insulator 16.

In addition to the cost savings of utilizing the lower cost support materials, other economies are realized in the novel design and assembly techniques in the present invention. Rather than employing a conductive connection between the feedline and antenna, a capacitive coupling is employed. This approach provides for lower assembly costs and reduced likelihood of defects in the assembly process. Because each layer is prefabricated and stacked, with alignment controlled by the screw fasteners 30, the feedline connector 14 is merely dropped into the hole formed in antenna shield 2, covered with feedline connector insulator 16 (which is self adhesive tape, thereby retaining it in place until assembly is completed) and then retained as the additional layers are stacked. This low cost approach yields a high performance antenna that is readily mass-producable.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A low cost microstrip antenna comprising:
a shield having a first surface;
a microstrip antenna board having a microstrip feedline on a first surface;
a feed support, fabricated from a closed cell foam sheet material of the variety that is mass produced for primaly purposes other than electrical insulation, and wherein
said feed support is placed adjacent to said first surface of said shield and insulating therefrom said microstrip antenna board, which is placed adjacent to said feed support with said first surface of said microstrip antenna board oriented to face said shield.

2. A low cost microstrip antenna comprising:
a shield having a first surface with a hole formed therein;
a microstrip antenna board having a microstrip feedline on a first surface;
a feed support, fabricated from a closed cell foam sheet material of the variety that is mass produced for primary purposes other than electrical insulation;
a feedline connector located in said hole in said shield and having a coupling member exposed at said first surface of said shield;
a feedline insulator covering said coupling member of said feedline connector, and wherein,
said feed support is placed adjacent to said first surface of said shield and insulating therefrom said microstrip antenna board, which is placed adjacent to said feed support with said first surface of said microstrip antenna board oriented to face said shield, and, said microstrip antenna board oriented such that said microstrip feedline is oriented adjacent to said coupling member of said feedline connector and insulated therefrom by said feedline insulator, thereby forming a capacitive coupling there between.

3. A low cost microstrip antenna comprising:
a shield having a first, substantially planar, conductive, surface with a hole formed therein;
a microstrip antenna board having a microstrip feedline coupled to a radiating element on a first surface;
a feed support, fabricated from a fine celled irradiation cross linked polyolefin foam sheet material, having substantially the same planar dimensions as said microstrip antenna board;
a feedline connector having a coupling member, said feedline connector located in said hole in said shield such that said coupling member is exposed at said first surface of said shield;
a feedline insulator covering said coupling member of said feedline connector, and wherein,
said feed support is placed adjacent to said first surface of said shield and insulating therefrom said microstrip antenna board, which is placed adjacent to said feed support with said first surface of said microstrip antenna board oriented to face said shield, and, said microstrip antenna board oriented such that said microstrip feedline is oriented adjacent to said coupling member of said feedline connector and insulated therefrom by said feedline insulator, thereby forming a capacitive coupling there between.

4. The low cost microstrip antenna in claim 3 and wherein said feed support is fabricated from Volara brand polyolefin foam packing material.

5. The low cost microstrip antenna in claim 3 further comprising:
a patch radiator board having a patch radiator element on a first surface;
a patch support, fabricated from twinwall corrugated polyolefin resin sheet material, having substantially the same planar dimensions as said patch radiator board, and wherein
said patch support is located adjacent to a second surface of said microstrip antenna board, and said first surface of said patch radiator board is located adjacent to said patch support and positioned such that said patch radiating element is electromagnetically coupled to said radiating element of said microstrip antenna board.

6. The low cost microstrip antenna in claim 5 and wherein said feed support is fabricated from Coroplast brand twinwall corrugated polyolefin resin sheet material.

7. A method of assembling a low cost microstrip antenna having a shield with a hole formed therein, a feed support, a microstrip antenna board having a microstrip feedline on a first surface, a feedline connector having a coupling member, and a feedline insulator, comprising the steps of inserting
the feedline connector into the hole in the shield;
placing the feedline insulator over the coupling member of the feedline connector;
stacking the feed support on the shield;
aligning and stacking the microstrip antenna board on the feed support such that the microstrip feedline on the microstrip antenna board substantially aligns with the coupling member of the feedline connector, and
fastening the shield, feed support and microstrip antenna elements together whereby the feedline connector is held captive between the shield and microstrip antenna element with the coupling member of the feedline connector substantially aligned with the microstrip feedline on the microstrip antenna element and insulated therefrom by the feedline insulator thereby forming a capacitive coupling there between.

8. A low cost microstrip antenna comprising:
a shield having a first, substantially planar, conductive, surface with a hole formed therein;
a microstrip antenna board having a microstrip feedline coupled to a radiating element on a first surface;
a feed support, fabricated by cutting a fine celled irradiation crosslinked polyolefin foam, having substantially the same planar dimensions as said microstrip antenna board;
a feedline connector having a coupling member, said feedline connector located in said hole in said shield such that said coupling member is exposed at said first surface of said shield;
a feedline insulator covering said coupling member of said feedline connector, and wherein,
said feed support is placed adjacent to said first surface of said shield and insulating therefrom said microstrip antenna board, which is placed adjacent to said feed support with said first surface of said microstrip antenna board oriented to face said shield, and, said microstrip antenna board oriented such that said microstrip feedline is oriented adjacent to said coupling member of said feedline connector and insulated therefrom by said feedline insulator, thereby forming a capacitive coupling there between.

9. The low cost microstrip antenna in claim 8 and wherein said feed support is fabricated from Volara brand fine celled irradiation crosslinked polyolefin foam.

10. The low cost microstrip antenna in claim 8, further comprising:
a patch radiator board having a patch radiator element on a first surface;
a patch support, fabricated by cutting a twinwall corrugated plastic sheet material which is made from polyolefin resin, having substantially the same planar dimensions as said patch radiator board, and wherein
said patch support is located adjacent to a second surface of said microstrip antenna board, and said first surface of said patch radiator board is located adjacent to said patch support and positioned such that said patch radiating element is electromagnetically coupled to said radiating element of said rnicrostrip antenna board.

11. The low cost microstrip antenna in claim 10, and wherein said feed support is fabricated from Coroplast brand twinwall corrugated polyolefin resin sheet material.
